(19) United States
(12) Patent Application Publication
(10) Pub. No.: US 2006/0228269 A1
(43) Pub. Date: Oct. 12, 2006

(54) Ozone protective system: vehicle and mechanical engine carbon and exhaustive gaseous filtration system

(76) Inventor: Rupert Samuel Williams JR., Powder Springs, GA (US)

Correspondence Address: RUPERT SAMUEL WILLIAMS JR. P.E., 343 YELLOWSTONE DRIVE, POWDER SPRINGS, GA, 30127, US

(21) Appl. No.: 11/103,190

(22) Filed: Apr. 11, 2005

(51) Int. Cl. B01D 53/34; B01D 50/00

(52) U.S. Cl. 422/168; 422/169; 422/173

(57) ABSTRACT

An Ozone Protective System comprised of a Vehicle and Mechanical Engine Exhaustive Gaseous Filtration System, housed in an elongated cylinder comprised of a chamber or series of chambers, placed at a strategic singular or an arbitrary point along a proposed or an existing vehicle or mechanical exhaust system, with devices, chambers, compartments, fans, blades, and air paddles, for the purpose of receiving and transporting gaseous exhaust from the system's connecting point of entry, through the designed filtration system and to the exit point. The said designed filtration system senses, detects, and calculates the velocity, temperature and chemical characteristics of the exhaust and detects the presence of carbon, nitrogen, oxygen, hydrocarbons, and other gases, and proceeds to transport the exhaust by force from the fans, blades, and air paddles through a chilling and humidifying process within the chilling chamber and on to the filtration unit. The chamber or series of chambers further circulate the exhaust through decreasing fractional iterations by method of suction, thereby transporting filtered exhaust by the process of two directional flows based on the angle of the fan blades, and circulating the exhaust through the filtration unit, transports the remnant back to the original chamber for further recirculation or transport to the next chamber, or to the system exit. This invention utilizes design features of the preferred embodiment to emulate the natural chemical, physical, and biological characteristics, which occur in the natural atmospheric environment, following patterns and cycles, which cleanse air of pollutants, such as those which result from exhaust from motor engines or mechanical systems, through nature's own self-cleansing process.

### DESCRIPTION OF THE INVENTION

1. Field of the Invention

This invention relates to a system which filters exhaust from vehicles and mechanical engines by emulating and utilizing the naturally occurring filtration process found in nature to cleanse the atmosphere of contaminants, namely, carbon, nitrogen, oxygen, hydrocarbons, and other exhaustive gases emitted by engines and, mechanical production systems.

2. Background of the Invention

The invention is comprised of an ozone protective system which is designed to filter carbon and other gases from exhaust emitted from a motor engine, namely a Vehicle and Mechanical Engine and Vehicle Carbon and Exhaustive Gaseous Filtration System.

There have been attempts in the past to utilize various methods for filtering carbon and other gases from vehicle exhaust, mostly using chemically enhanced filters or electrically charged systems.

This novel invention utilizes a process that emulates the naturally occurring self-cleansing system in the atmospheric environment, and uses a metallic elongated cylinder that is divided into one or more chambers that utilize variance in temperature, pressure, force, to enhance filtration to remove carbon, nitrogen, and hydrocarbons, and other gases from the exhaust of a motor engine.

The primary difference between this invention and others similar to this field, is that this system uses a predominantly natural process which seeks to not engage chemical or electrical reactions by passing exhaustive gases through filters that are lined with chemicals or electrical fields or processes. The process used by the preferred embodiment also does not provide electrical charges to gases in attempting to oxidized and filtrate.

The method of treating exhaust gases from a methanol fueled internal combustion engine observed in to U.S. Pat. No. 4,304,761, which was issued to Mr. Yao, utilizes a process that involves passing unburned Methanol over a catalyst consisting of silver dispersed on a washcloth material. Mr. Yao's invention also thermally ages the washcloth material by heating it up to 1000° C., for up to six hours. The method used in our novel invention, on the contrary, lowers the temperature of the exhaust and its surrounding air to as near freezing temperature as possible. Its filters preferably contain no chemical enhancements or treatments, but simply consist of semi-porous or semi-permeable membranes, preferably from naturally occurring materials.

Similarly, in a method of simultaneously oxidizing carbon monoxide and unburned fuel in methanol vehicle exhaust, observed in U.S. Pat. No. 4,673,556, issued to McCabe, et al., used a process that oxidized the unburned methanol and carbon monoxide by passing the exhaust gases over a catalyst system consisting essentially of silver and palladium dispersed on gamma alumina. McCabe, et al., also disclose that their process uses rapid oxidation of methanol by achieving temperatures that are high enough to remove the carbon monoxide either by absorption or reaction with oxygen. The preferred embodiment comprises of a system that uses very low temperatures, no chemicals, and direct filtration to remove or filter contaminants from gaseous exhaust.

In an activated carbon filter for reducing vapor emissions from a fuel supply system including a filter housing, U.S. Pat. No. 6,773,491 issued to Bohl, an activated filter consisting in part of a filter material layer of highly absorptive material disposed between the activated carbon filter section and the connecting section, with the highly absorptive material consisting of at least one of the zealite, silicious gel, aluminum oxide, di-vinyl benzene styrol material and aluminum oxide. Bohl also discloses that in Chamber 7 by the filter layer 15, heating the filter layer or the respective closure provides for rapid regeneration of the filter layers or, the closure, and also provides for rapid release of the hydrocarbons from the activated carbon pellets. As noted, this invention uses no heating chemical layers or chemically enhanced filters, but uses natural or as near to natural as possible, layers to absorb, separate, and capture contaminants in exhaustive gases from engines.

The preferred embodiment takes contaminated exhaust from an engine, and through a replication of nature's own self-cleansing process, uses the features of nature, namely, temperature, pressure, saturation, absorption, and filtration, to cleanse the air of contaminants such as carbon and other dangerous gases.

### A BRIEF DESCRIPTION OF DRAWINGS

The invention shall be described in detail with reference to several drawings, in which

FIG. 1 is a schematic diagram of the general system comprising the preferred embodiment.

FIG. 2 is a schematic diagram of the preferred embodiment of a Chilling chamber.

FIG. 3 is a drawing of a general view of the system and a possible location of the invention.

FIG. 4 is a drawing of a general view of the system.

FIG. 5 is a drawing of possible variations of the chilling chamber of the preferred embodiment.

FIG. 6 is a drawing of a plan view of the preferred embodiment.

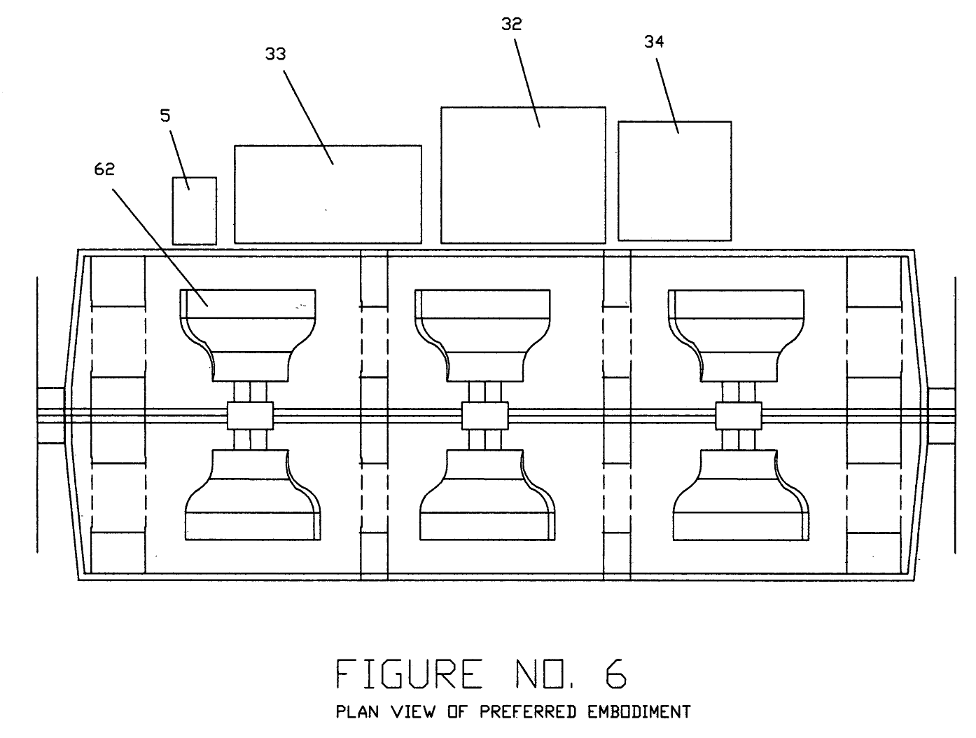

FIG. 7 is a drawing of a front elevation of the preferred embodiment.

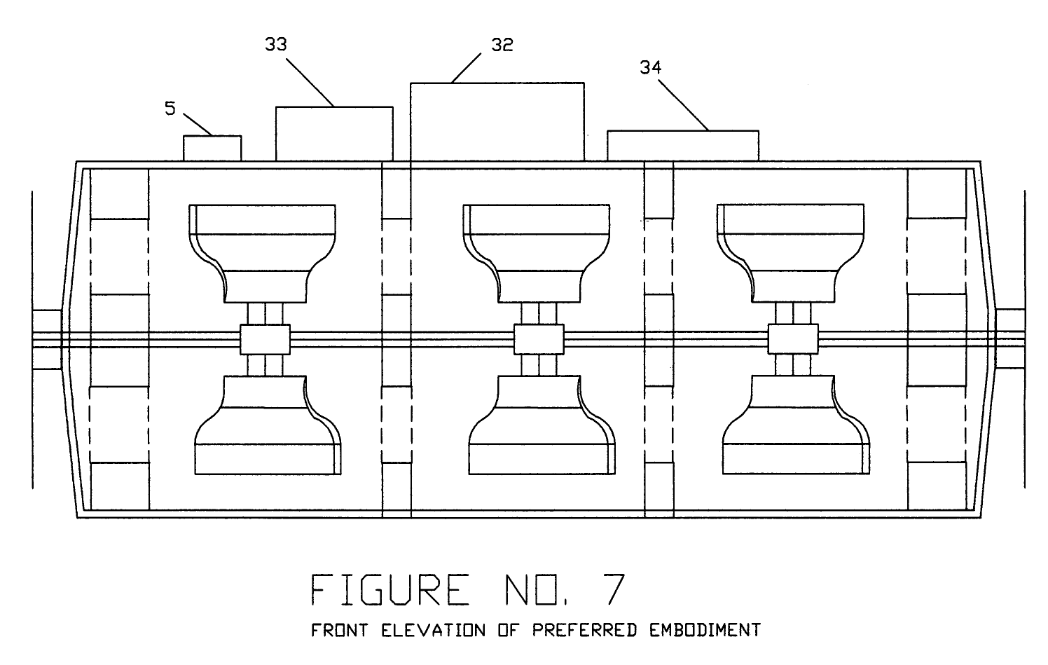

FIG. 8 is a display of detailed drawings of the fan assembly.

FIG. 9 is a drawing of a possible design detail of the preferred embodiment of the filter.

### SUMMARY OF THE INVENTION

Observation of the stratosphere, particularly at the lower levels, clearly displays atmospheric sequences which pertain to the environment's natural cycle for the removal of pollutants which contaminate the air from gaseous emissions that come from production and industrial mechanical devices, and motor engines in vehicles. Over the years, several attempts have been made to filter dangerous gases such as carbon, nitrogen, hydrocarbons, nitric acid and others from the exhaust which results from a fueled engine. Most, if not all of these attempts have been based on two primary principles, including but not limited to the heating of a singular or various aspects of the elements, or parts of the invention for the purpose of oxidizing or filtering, and, lining the filter with some form of metallic or chemical component thereby causing a chemical reaction which aids in the oxidation process.

The primary principle and theory supporting this novel invention are opposite to both the concept of heating for filtration and, chemical, electrical or metallic reaction primarily for oxidation. The preferred embodiment seeks to emulate nature's self cleansing process and cycles by taking the exhaustive gases from the engine through as close to a natural atmospheric cycle as possible, similar to that found in nature, to rid the exhaust of pollutants.

Observing an urban metropolitan atmosphere, we notice that during the hot summer months, the air is thick and saturated with “smog,” which is the resultant of a compilation of emissions from vehicle engines and other sources. The founding theory rests on the on the premise that if the number of vehicles and the contaminating emissions from vehicles and other sources remains constant throughout the year, then there must be a rationale for certain days during the winter months when the atmosphere receives the same amount, if not more contaminants, yet there is obviously less visible “smog” or invisible and vivible pollutants in the atmosphere, concluding that the fluctuation of the atmospheric variables such as relative humidity, atmospheric pressure, temperature, and the absorptive characteristics of air all represent independent, inter-related and collective roles in the atmosphere's self cleansing process.

The present novel invention is comprised of a system for ultimately protecting the ozone layer in the atmosphere by utilizing a series of chambers embedded with filters which oxidize carbon and other gases emitted from a motor engine.

This system seeks to emulate as closely as possible, the natural cleansing system that occurs in nature in the purification and filtration process with respect to removing gaseous emissions from the atmosphere. In nature, there are varying fluctuations of the characteristics of air including, pressure, temperature, humidity, and absorptive characteristics which ultimately impact the atmosphere's ability to absorb and rid itself of gaseous contaminants such as carbon, nitrogen, hydrocarbons, nitric acid, and other harmful residuals.

This preferred embodiment is comprised of an elongated metallic cylinder to be located at any point along an exhaust line, beginning at the first exit point for exhaust leaving an engine. The system can also be placed before any device along the exhaust line including but not limited to catalytic converters or mufflers, as the features of the embodiment are designed not to interfere with such otherwise.

The exhaust from the motor engine enters the metallic chamber, which may have an optional back flow prevention unit for larger or more complex systems. The exhaust system is designed to allow the free flow of exhaust at all times, and at no point along the process is there to be a prevention of flow of exhaust which may cause a back flow.

The elongated cylinder has its wall lined preferably with a singular or varying levels or layers of filters which are semi-permeable and unlined with chemical or metallic liners to enhance oxidation. The natural state of the preferred embodiment comprised of cloth-like or similar type filter will provide a designed surface for filtration and collection of gaseous residual.

Within the elongated chamber are smaller separate chambers which each have a fan unit in the form of fan blades, oars, belts, or similar for the purpose of rotating and forcing air through the chamber and filter. Chilled air and dehumidification properties are sent through the chamber and are further engaged in the rotational process to assist in filtration. The fans also simultaneously transport the exhaust and air to the next chamber.

The cooling or chilling supply and a dehumidification source provide increased parameters and fluctuations of the internal characteristics and conditions of the gaseous exhaust and the air, thereby lowering the temperature and increasing the absorptive capabilities of the system. The chilled air is vacuumed by a series of tubes form the internal area inside the chamber through the filtration system by centripetal force from the fan blades, and pumped back into the inner chamber free of contaminants.

The exhaust is then pushed down to the next chamber by the lateral forces of the blade and the natural flow of the system, undergoing a repetition of the above mentioned process through a series of overlapping iterations, ultimately filtering the exhaust from carbon, nitrogen, nitric acid, hydrocarbons and other harmful gases.

### DETAILED DESCRIPTION OF THE INVENTION

This invention, an Ozone Protective System, which is comprised of a vehicle and mechanical engine carbon and exhaustive gaseous filtration system, consisting of a preferred embodiment, which has a primary function that involves the filtration of exhaust from a motor engine or a production system, removing pollutants which are harmful to the atmosphere in general and the ozone layer in particular.

The fundamental principles upon which this invention are based is found in the natural environment, namely the self cleansing process used by nature to remove gaseous contaminants from the atmosphere, in particular, excess nitrogen, carbon, oxygen, hydrocarbons and other gases which are emitted as a residual from chemical reactions that occur in vehicle, motor engines, and production processes.

Observing the atmosphere around a metropolitan area, contaminants resulting from excess carbon, nitrogen, oxygen, and hydrocarbons from motors, can be clearly seen on warm summer days, reducing visibility and in particular creating contaminants that are harmful to people, the community in general, and the atmosphere, especially the ozone layer. As previously stated, during the hot summer months, the air is thick and saturated with “smog” which is the resultant of a compilation of emissions from vehicle engines and other sources. Recalling that the founding theory rests on the on the premise that if the number of vehicles and the contaminating emissions from vehicles and other sources remains constant throughout the year, then there must be a rationale for certain days during the winter months when the atmosphere receives the same amount, if not more contaminants, yet there is obviously less visible “smog” or pollutants in the atmosphere, concluding that the fluctuation of the atmospheric variables such as relative humidity, atmospheric pressure, temperature, and the absorptive characteristics of air all represent independent, inter-related and collective roles in the atmosphere self cleansing process.

The processes contained in this invention emulates as closely as possible, the characteristics of nature, by producing fluctuations in the pressure, relative humidity, and temperature within the chamber of the preferred embodiment. These fluctuations occur at critical points along the process allowing filtration of contaminants, by taking advantage of the bonding tendencies and chemical characteristics of the elements in the exhaust and its surrounding atmosphere within the chambers of the device.

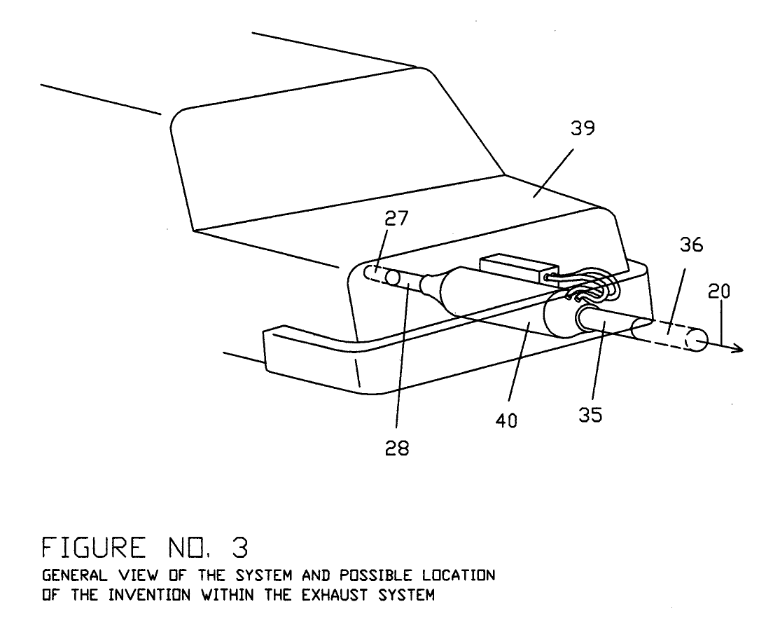

The said filtration system is embodied within a general metallic cylindrical system FIG. 3, placed at an arbitrary point along the exhaust line (27) of a vehicle (39), motor engine or production process, for the purpose of receiving exhaust, filtering it and transporting it through the exit point of the device. Exhaust is received form the exhaust pipe or line into the device entry chamber (28), and proceeds through a series of chambers contained within a metallic elongated cylinder (40), which contains components that contribute to a process of filtration, and thereafter transports the filtered exhaust through the exit point (35), thereby proceeding to the rest of the exhaust system (36), or to the open atmosphere (20).

Similar to natural occurrences within the environment, as the temperature and relative humidity within the atmosphere is reduced, and the self cleansing process of nature occurs, likewise within the system, a process occurs which the relative humidity and the temperature, in order for the elements to take advantage of the chemical bonding process, which may relate to the bonding and prevention of bonding, of particular chemical elements.

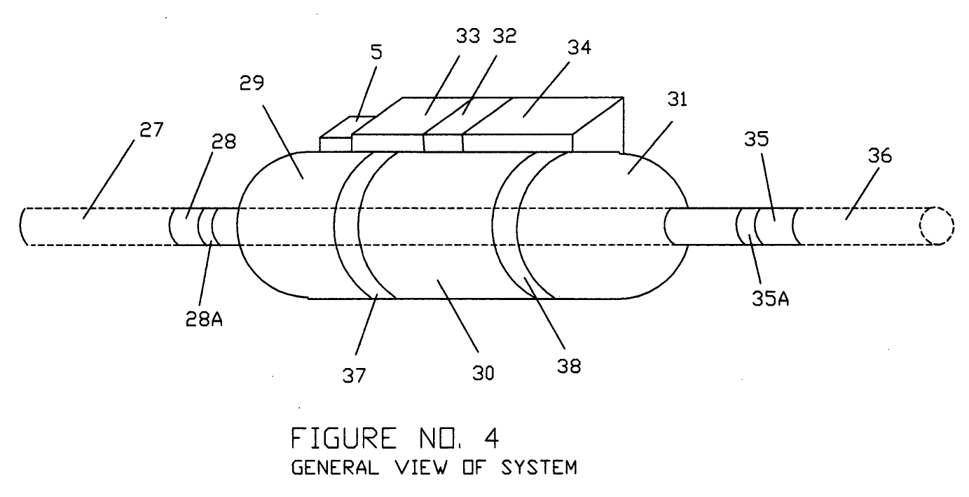

From FIG. 4, a more detailed representation of a possible preferred embodiment is displayed. The exhaust enters into the entry point of the device (28) unobstructed, and proceeds through a primary backflow prevention device (28A) thereby entering the first chilling chamber (29) which is comprised of independently rotating fans or propelling devices, which provide the chamber with support for the filtration process and transportation means of propelling the exhaust through the filtration process and then on to the next chamber (30). The chambers are separated by a separation element (37) which consist of an orifice of sufficient size to permit exhaust to flow through the filtration system in the walls of the cylinder, and then on to the next chamber through the orifice.

After proceeding through the second chamber, the exhaust proceeds through the second separation element (38) and then on to the third chamber (31), both of these said chambers being optional, depend on design requirements.

From the final filtration chamber, the exhaust proceeds to the secondary backflow prevention device (35), which prevents the exhaust form proceeding back into the system. The exhaust then enters into the exit chamber (35A), thereafter entering the vehicle or otherwise exhaust pipe (36) or into the open atmosphere.

The preferred embodiment receives necessary electrical power (32) from an independent or dependent supply as determined by design, namely from the vehicle or motor battery supply or from an independent designed source. The individual chambers are supported by a dependent or independent temperature lowering system (33) for the purpose of chilling the exhaust and air in each chamber. The chambers are also supported by a dependent or independent dehumidification system (34) which removes atmospheric humidity or moisture from the air and exhaust in the chamber.

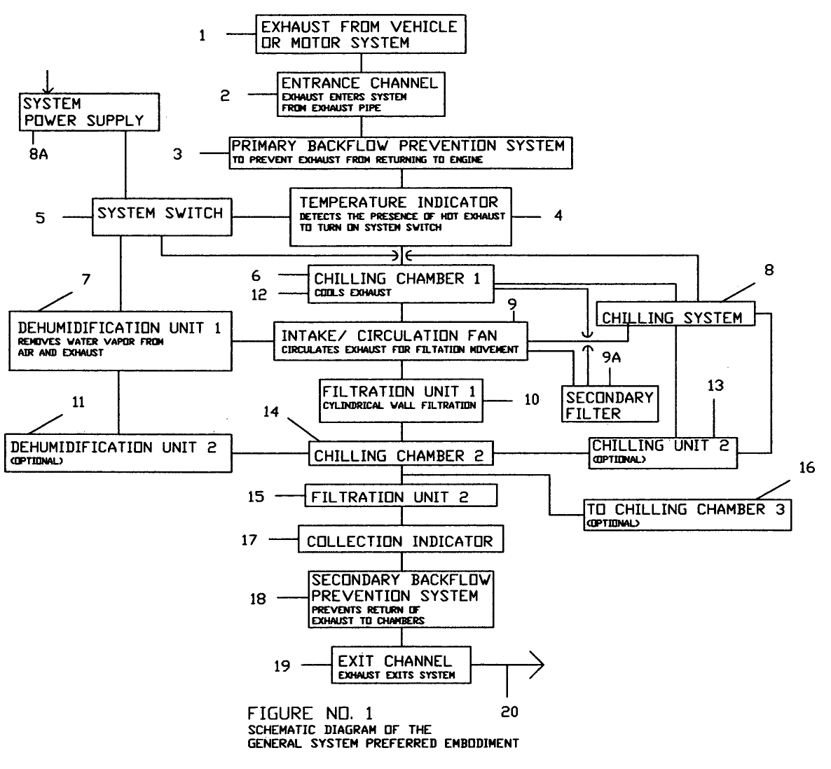

FIG. 1 shows a schematic diagram of the entire process of the preferred embodiment, displaying the initial entry point of the exhaust into the system (1). This entry point can occur anywhere along the exhaust line, beginning at the closest point to the pipe exit from the engine, and including the preferred embodiment being the last device comprising the exhaust system, and emitting filtered exhaust into the open atmosphere. In the event that the device is placed prior to an existing or design feature such as a muffler or catalytic converter, the system is designed to include a velocity sensor, indicator and speed selection device, for the purpose of determining the velocity of the incoming exhaust, and setting the velocity of the fans in the chambers to corresponding speeds to maintain constant velocity between the entry and exit points in the system, in order to prevent interference with existing or external systems not related to the embodiment.

After leaving the exit point of the engine or tailpipe and entering the system at the entrance channel (2), the exhaust enters a primary backflow prevention system (3) which is designed to prevent traveling exhaust from moving back towards the engine or tailpipe.

From the primary backflow prevention system, the exhaust moves to a series of sensors and indicators (4), namely a temperature sensor, a velocity sensor and a speed selection device. The temperature sensor detects the presence of heated exhaust entering the system, and independently triggers the system switch (5), which can also be triggered by the velocity sensor mentioned in (4). The switch can be optionally set to turn on independently, manually, or automatically, intermittently, or continuously by the ignition system or otherwise. The switch is designed to identify one impulse from either the temperature sensor or velocity sensor or otherwise without interference of signals.

After the exhaust leaves the primary backflow prevention system and goes through the sensors, it arrives into the initial chilling chamber (6) and (12), and (29) of FIG. 4, which is supported by a chilling system (8) and a dehumidification unit (7). The chilling chamber's temperature is reduced by a corresponding respective source, namely, the chilling system, having a dependent or independent source of cooling, either from the vehicle or otherwise air conditioning or air control system, or from a system designed specifically for the preferred embodiment. The relative humidity within the chilling chamber is reduced by a dehumidification unit, which may be comprised of a dependent or independent support system.

The exhaust and air within the chilling chamber, after undergoing changes in temperature and humidity, are subjected to two directional rotations. Primarily the force on the air and exhaust is created by the movement of the fan blades, which are located in the intake/circulation fan assembly (9). These fans may consist of blades, belts, oars, air paddles or otherwise designed to provide simultaneous two directional air moving as a result of centrifugal forces, primarily towards the filtered walls of the chamber, the filtration unit (10), and secondarily towards the next chamber or toward the exit. The filtration unit shall include a secondary minor system (9A) to independently sending fresh filtered air in from the free atmosphere, in through a separate filtration system, to allow additional uncontaminated air into the chamber. This additional, less or uncontaminated air shall increase the cleansing and absorptive characteristics of the chamber and system.

Depending on the complexity of the design, the system may contain a singular chamber or a series of chambers, displayed as a second chilling chamber (14), which has a corresponding second dehumidification unit (11), which is also optional, and each chilling chamber also may have an optional corresponding second chilling supply unit (13). This and any additional chambers (14) and (16) have their corresponding independent fan or blade rotational system, and a separate but similar filtration unit (15), which through a process of suction, transports the exhaust from the inside of the chilling chamber, and aided by the force from propelling fans, takes the exhaust through the filter unit comprised of a filter fabric or semi-permeable membrane, or designed fabric lined membranes, which is monitored by a collection indicator (17).

After leaving the final chamber (16), the exhaust enters a secondary exit (18), which is comprised of a second backflow prevention unit, similar to the primary unit (3) found at the device entrance. From the exit channel, the filtered exhaust enters the exit channel (19) and from there exits the system into the connecting exhaust pipe or into the free atmosphere (20). The exhaust at this point, having undergone a series of processes designed to have filtered contaminants created during the chemical process in the engine.

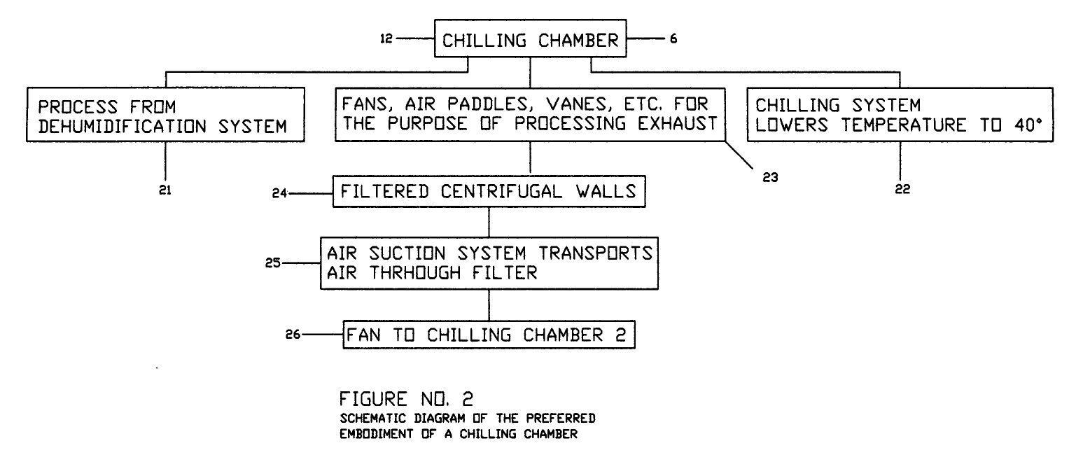

FIG. 2 is a representation of a possible schematic diagram of the preferred embodiment, specifically a detail of the chilling chamber (6) and (12) and its components. The chilling chamber receives exhaust, and the exhaust and air experiences a temperature drop from the chilling system (22) which is designed to lower the temperature, to as low as possible, but preferably to at least 40° C. or as close to freezing temperature (32° C.) as possible. The lowering of the temperature creates an atmosphere in the chamber that prevents specific chemical reactions from taking place in some cases, and allows others to take place for a consummate resultant which is advantageous to the atmosphere in the chamber and the filtration process. The atmosphere within the chilling chamber experiences dehumidification from the dehumidification system (21), which removes moisture from the environment in the chamber, thereby preventing particular chemical reactions from taking place in specific instances, and allowing other reactions to occur, in totality, for the benefit of the filtration process and the chamber environment, similar to the process found in nature.

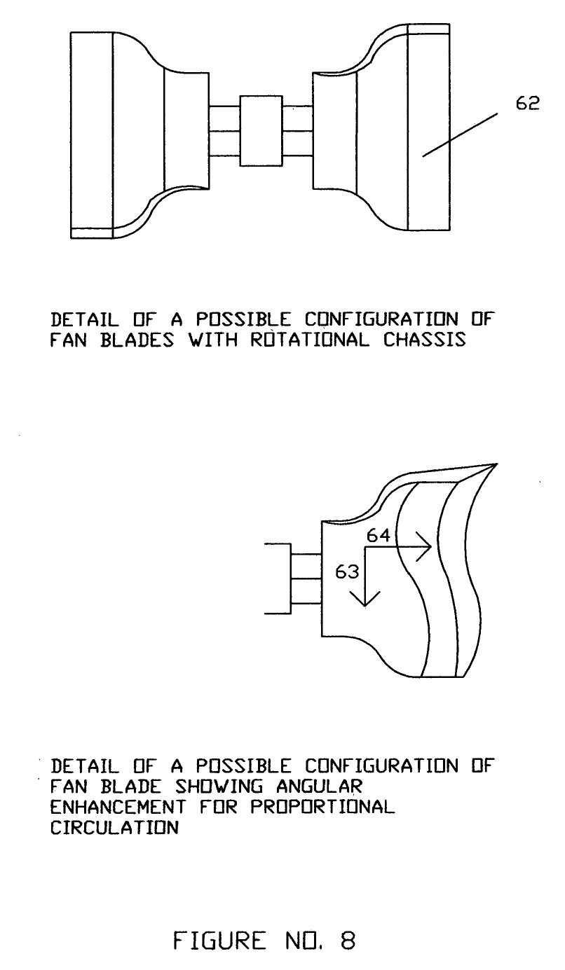

The chilling chamber is also equipped with an arrangement of fan blades (23) air paddles, vanes, oars, or other wind or air driving devices (62), from FIG. 8, that propel the air in the chamber to create centrifugal forces that transport the exhaust in two directions, by directional proportionality. This proportionality is designed relative to the detected and targeted velocity of the longitudinal movement of the exhaust entering the system, specifically, the fan blades work in unison with the suction aspects of the design to move the exhaust through several possible iterations of filtration through the filter walls, and simultaneously moving some of the exhaust towards the next chamber, or towards the exit. For example, the angles, thickness, length or other characteristics of the blades (63) and (64) may be designed to send seventy percent (70%) of the exhaust towards the walls and thirty percent (30%) towards the next chamber, and the rotational velocity of the blades relate to the speed at which the exhaust experiences both centrifugal and longitudinal velocities. The fan arrangement forces the exhaust primarily in the direction of the filtration wall (24) which is comprised of a semi-permeable membrane (65) designed to capture and entrap contaminants of the exhaust. The material comprising the filtration membrane may be lined with all natural non toxic material to enhance filtration.

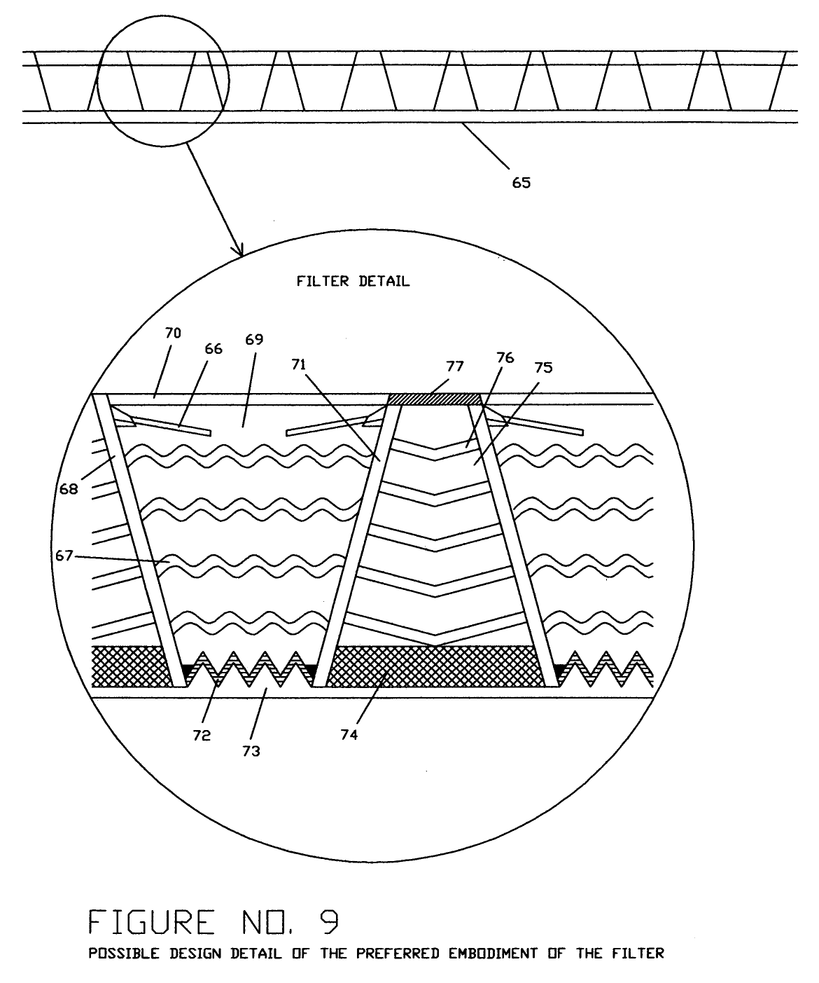

FIG. 9 shows a diagram of a possible design of a filter network, comprising of dual cells which are made up of a primary receiver cell and a secondary collector cell. The primary receiver cell is layered with a permeable layer (70) which covers fluctuation gills (66) which are designed to allow one direction flow of exhaust and contaminants, which filter through and collect into voids (69). Below the fluctuation gills are a series of semi-permeable membranes (67) which permit proportional travel of exhaust, with a design to retain contaminants. These membranes are supported by internal and external diagonal walls (68) and (71), joined at the bottom of the primary collector by a thicker more dense semi-permeable membrane (72), below which a suction area (73) permits and enhances the flow of exhaust through the filtration network FIG. 2, (25).

Adjacent to the primary receiver is the secondary collector (77) which is topped with a membrane similar to (72), the said collector receiving exhaust and contaminants through the internal layers (76) designed to store contaminants on a longer term basis (75). The base of the secondary compartment is made up of a material (74) stronger than (72). After receiving the designed number of filtered iterations, the filtered exhaust proceeds to the next chamber (26) or to the exit.

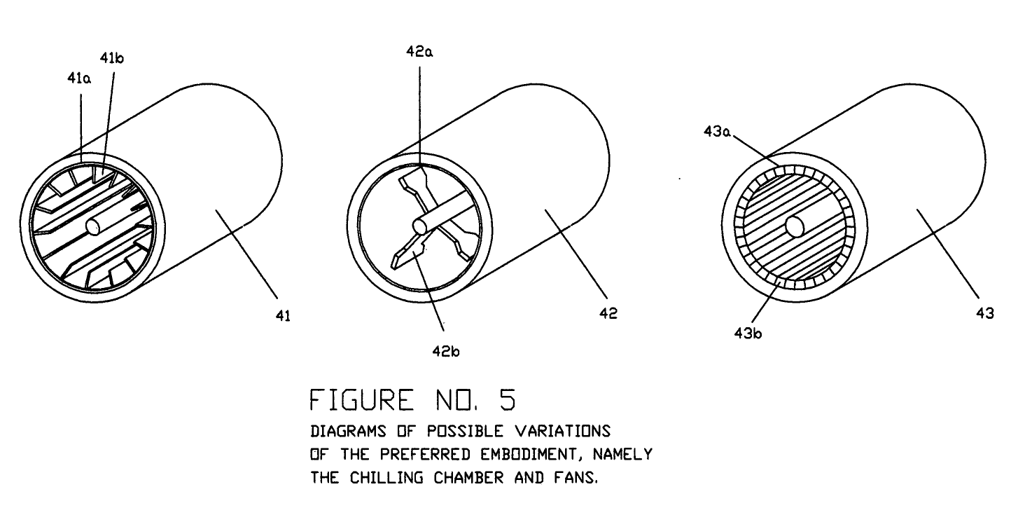

FIG. 5 show several views of possible arrangements of the components of the fan assembly of the chilling chambers, (41) shows evenly arrayed vanes around the interior of the chamber, with thin vanes aligned along the horizontal axis (41b) to create forces against the filtration network (41a). Likewise (42) shows a three blade system (42b) that pushes exhaust towards the wall filtration system (42a), and (43) shows a complex arrangement where the filtration system (43a) and the vanes (43b) are in rotation.

The system may have its own designed power supply, FIG. 1 (8A) or power from an external source.

What is claimed is:

1. An ozone protective system comprised of a filtration system consisting of an elongated cylindrical metallic system which is divided into one or more separate chambers designed to oxidize, divide, or separate the variant chemical characteristics of gaseous exhaust emitted from a gasoline, methanol, diesel, or otherwise fueled engine or mechanical system.

2. The said elongated cylindrical metallic system unit of claim 1, being designed to be located at an arbitrary point along the exhaust system, for the purpose of filtration of exhaust, whereby intake exhaust received at the point of entry, moves to the exit point without obstruction along the system and through its compartments without creating backflow, or preventing forward progression.

3. The said cylindrical chamber of claim 1, comprised of a housing unit, featuring a chilling chamber, durable to withstand variable temperatures ranging from high temperatures related to that of the exhaust, and tolerable to the low temperatures relative to the characteristics of the chilled air from the said chilling chamber.

4. The said cylindrical metallic system of claim 1, having a longitudinal axis of rotation around which optional geometrically designed enhanced fans, oars, belts, blades, or air paddles, which rotate independently with respect to corresponding similar components in other similar adjacent chambers, for the purpose of creating centrifugal forces which aid in the oxidation separation and division process.

5. The said one or more separate chambers of claim 1, and the fans, blades, oars, or air paddles of claim 4, which rotate around the longitudinal axis of rotation at independent speeds, and possibly independent rotational directions, provide forced exhaust into the filtration system, which is comprised of a cylindrical wall lined unit preferably with an all natural, non-toxic, semi-permeable filtration membrane, the power supply provided by an internal designed motor.

6. The said fans, oars, belts, blades, or air paddles of claim 4, may be placed in a particular independent rotation with respect to each chamber as per claim 5, and may rotate or operate in sequence or in contrast of the design characteristics of the said chamber, with respect to the velocity and direction of the mentioned relevant components.

7. The said filtration system of claim 1, comprised of the cylindrical wall lined independent all natural, non-toxic semi-permeable membrane of claim 5, simultaneously oxidizes, separates, and divides, segregates, or diminishes hydrocarbons, carbon, nitrogen, nitric acid, or other gases emitted from motor engines.

8. The said cylindrical metallic system of claim 1 uses dependent or independent methodology to lower the temperature of the exhaust, surrounding air, returning and secondary filtered air, physical elements and parts of the device, which comprise the preferred embodiment.

9. The said cylindrical wall lined unit of claim 5, and the said semi-permeable filtration membrane of the same claim shall cover the inner wall of the cylinder in circular formation to support and allow a suction process for the purpose of filtration, and, on more complex designs, the filtration system itself may rotate independent to each individual chamber.

10. The said cylindrical system chamber of claim 1, and it's supporting components, in its general function and process, are in totally, essentially comprised of a design criteria which emulates the atmospheric, chemical, physical, and biological patterns and cycles which cleanses natural air of contaminating chemicals and residual pollutants.

11. The said cylindrical metallic system of claim 1 and the aforementioned patterns and cycles of claim 10, are designed to enhance the respective parts, elements, and embodiments of the device, to emulating atmospheric pressure, relative humidity, temperature, various densities and independent and dependent saturation characteristics and indexes of natural air, in particular, the lowering both the relative humidity and the percentage of moisture in the atmosphere are key design features that contribute to the filtration system of the embodiment.

12. The said filtration system of claim 1 and claim 5, is comprised of all naturally occurring material and may consist of one or more layers of cloth, fiber, or other semi-permeable material, being placed in such a manner to retard, collect, and optionally measure the quantity of pollutants and to allow replacement such filter or filtration unit as necessary.

13. The said elongated cylindrical metallic system of claim 1, and the chilling chamber of claim 3, shall be comprised preferably as minimal singular, but preferably dual or multiple chambers, connected in parallel or series, using channels, tubes, hoses, and suction devices to circulate air and exhaust from inside the chamber, through the filters, on to the chamber walls, and back into the respective original chamber.

14. The said elongated cylindrical metallic system of claim 1, and the chilling chambers of claim 3, and claim 13, shall each be comprised of an independent dehumidification support unit comprised of motors, compressors, devices, hoses, nozzles, compartments, and such support mechanisms which aid in the dehumidification of the exhaust and air in each chamber.

15. The said ozone protective system of claim 1 shall be comprised of electronic and electrical components including wires, switches, and connections to obtain power from a dependent power source such as a vehicle battery or having an optional independent electrical power supply.

16. The said cylindrical wall lined unit of claim 5, and the said semi-permeable material from claim 12, shall comprise of a designed material which permits one way flow of contaminants into the material.

17. The all naturally occurring material of claim 12, is a design preference, and if circumstances require a design utilizing chemical, electrical or otherwise enhanced filtration material, such design shall not compromise the safety or integrity of the natural environment beyond a reasonable measure.

18. The said suction devices of claim 13, shall provide an independent system to filter air into the respective chilling chamber, bring in additional air from the free atmosphere, from outside the system, and filtering it into the system to rid the free air of pollutants in the open atmosphere, in order to enhance the filtration processes within the system.

19. The said ozone protective system and the filtration system of claim 1, and the design elements of all features and mentioned claims, are relevant to and shall include filtration systems for the exhaust and gaseous waste from all motors, industrial production plants and systems, including chimneys, stacks, and all processes that involve the creation of residual chemicals and pollutants that are emitted into the free air.
